(19) United States
(12) Patent Application Publication
(10) Pub. No.: US 2019/0329892 A1
(43) Pub. Date: Oct. 31, 2019

(54) FLOOR FIXING ASSEMBLY AND SEAT FIXING SYSTEM, SEAT AND AIRCRAFT WITH A FLOOR FIXING ASSEMBLY

(71) Applicant: Airbus Operations GmbH, Hamburg (DE)

(72) Inventor: Ingo ROTH, Hamburg (DE)

(21) Appl. No.: 16/373,186

(22) Filed: Apr. 2, 2019

(30) Foreign Application Priority Data
Apr. 30, 2018 (DE) 10 2018 110 336.0

(51) Int. Cl. B64D 11/06

(52) U.S. Cl. CPC B64D 11/0696

(57) ABSTRACT

A floor fixing assembly for variable fixing of a frame to a vehicle floor, with a frame fixing element which is connected to a leg or a foot of the frame and which comprises a receiving space. The floor fixing assembly also comprises a floor fixing element which is inserted into the receiving space by form fit and which comprises at least one floor anchoring element. The floor anchoring element is arranged asymmetrically in the floor fixing element. A seat fixing system, a seat and an aircraft, each with at least one floor fixing assembly, are also disclosed.

### CROSS-REFERENCES TO RELATED APPLICATIONS

This application claims the benefit of the German patent application No. 10 2018 110 336.0 filed on Apr. 30, 2018, the entire disclosures of which are incorporated herein by way of reference.

### FIELD OF THE INVENTION

The invention concerns a floor fixing assembly with asymmetrically arranged floor anchoring elements, and furthermore concerns a seat fixing system, a seat and an aircraft with such a floor fixing assembly.

### BACKGROUND OF THE INVENTION

In vehicles, such as, for example, aircraft, buses, trains, ships etc., seats or seat rows are often attached to seat rails running in the longitudinal direction of the vehicle. The seat rails comprise regularly recurring openings and constrictions so that the seat or seat rows can be arranged and fixed in the vehicle at predefined spacings, depending on the spacing of two adjacent constrictions, in the longitudinal direction of the seat rails.

Vehicle operators require ever more flexible design possibilities for the interior of the vehicles. This includes rapid adaptation of the arrangement of seats or seat rows. For example, a vehicle operator may wish to offer a greater seat spacing, and hence increased comfort, in a specific region of the vehicle. Vehicle operators are however restricted to the spacing of the openings and constrictions in the seat rails.

Also, the majority of seat rails are never used over the life of the vehicle, whereby unnecessary weight is present in the vehicle.

### SUMMARY OF THE INVENTION

The invention is based on an object of providing a floor fixing assembly which allows a flexible and weight-saving arrangement of monuments, tables, seats, seat rows and similar elements to be fixed to the floor of a vehicle. Furthermore, the invention is based on the object of providing a seat fixing system, a seat and an aircraft, each with such a floor fixing assembly.

According to a first aspect, a floor fixing assembly for variable fixing of the frame to a vehicle floor comprises a frame fixing element and a floor fixing element. The frame fixing element is configured to be connected to a leg or a foot of the frame. The frame fixing element also comprises a receiving space. The floor fixing element may be configured to be inserted into the receiving space by form fit, and may furthermore comprise at least one floor anchoring element. Thus the frame may be positioned and oriented on the vehicle floor. Then the frame fixing element may be attached to the vehicle floor by form-fit insertion of the floor fixing element into the receiving space of the frame fixing element.

For example, the receiving space may have a shape which widens from one side of the frame fixing element—which is configured to point in the direction of the vehicle floor after installation in the vehicle—towards an opposite side of the frame fixing element. The floor fixing element (or more precisely, a body of the floor fixing element) may have a correspondingly tapering shape which is inserted into the receiving space by form fit. Thanks to the corresponding forms of the receiving space and floor fixing element, the floor fixing assembly may be secured to the vehicle floor.

Furthermore, the at least one floor anchoring element may be arranged asymmetrically in the floor fixing element. For example, a body of the floor fixing element may have a symmetrical periphery. Furthermore, the body of the floor fixing element is configured to be inserted into the receiving space in at least two mutually opposing directions. In other words, a (longitudinal) axis of the fixing element may be rotated through 180° relative to the frame fixing element, and thus be inserted into the receiving space in the opposite direction. Due to the fact that the at least one floor anchoring element is arranged asymmetrically, the at least one floor anchoring element is now arranged so as to be offset relative to the frame fixing element.

In an implementation variant, the body of the floor fixing element may have an elongate form, i.e., have the greatest extent along the longitudinal axis. Also, the body of the floor fixing element may have a form which is symmetrical in a cross-section parallel to a longitudinal axis of the body. In other words, the body of the floor fixing element is symmetrical in top view. This symmetry may be present in at least one cross-sectional plane running parallel to the longitudinal axis of the body. Here, the at least one floor anchoring element is arranged asymmetrically relative to a plane which is arranged perpendicularly to the longitudinal axis of the body of the floor fixing element and centrally in the longitudinal direction of the body. In other words, in top view onto the body of the floor fixing element, the floor anchoring element is arranged asymmetrically relative to a central point (symmetry point in top view) of the body. If now the floor fixing element is rotated through 180° in a top view of the body, the floor anchoring element lies at a different position in top view in each of the two positions of the body.

Furthermore, the receiving space may have an elongate form which is symmetrical in a cross-section parallel to a longitudinal axis of the receiving space. In other words, in a top view of the frame fixing element, the receiving space has a symmetrical form. This symmetry may be present in at least one cross-sectional plane running parallel to the longitudinal axis of the body of the frame fixing element.

Alternatively, the body of the floor fixing element and also the receiving space may have a circular form. Here too, the cross-section (in a top view) may taper towards the bottom so that a wedge effect occurs from the body of the floor fixing element in the receiving space. The body of the floor fixing element is divided into a specific number of equally-sized circle segments, wherein each segment has a through opening (bore). A floor anchoring element may be inserted by form fit into each of these openings. Each opening has a different distance (in the radial direction) from the outside of the body of the floor fixing element. In this way, the body of the floor fixing element may be inserted into the receiving space in specific angular positions corresponding to the circle segments, wherein the floor anchoring element may always assume a different asymmetry and hence a different distance relative to the floor fixing element when inserted into the corresponding opening. For example, the openings may be arranged in a spiral in a top view onto the body of the floor fixing element.

According to a further aspect, a seat fixing system comprises a plurality of fixing means arranged regularly in a row, and a seat frame. The seat frame may be attached to at least one floor fixing assembly according to the first aspect. Each of the plurality of fixing means arranged regularly in a row is configured to be coupled to a respective floor anchoring element of the floor fixing element of the floor fixing assembly. This coupling allows the seat fixing system to be attached to the plurality of fixing means.

In an implementation variant, the floor fixing element of the floor fixing assembly comprises two floor anchoring elements with a spacing which corresponds to the regular spacing of the fixing means arranged in a row. In other words, the floor fixing element and hence the seat fixing system are attached to two corresponding fixing means via two floor anchoring elements.

Alternatively or additionally, a spacing between a center axis of one of the at least one floor anchoring elements and an end of the floor fixing element situated in the longitudinal direction is smaller than the regular spacing of the fixing means arranged in a row. Because of the asymmetrical arrangement of the floor anchoring element in the body of the floor fixing element, the floor anchoring element has different distances from each end of the floor fixing element in the longitudinal direction of the floor fixing element. At least one of these two distances is smaller than the regular spacing of the fixing means of the seat fixing system arranged in a row.

Because of the asymmetrically arranged at least one floor anchoring element, and the possibility of inserting the floor fixing element into the frame fixing element in at least two arrangements (for example, rotated through 180°), the seat fixing system may be arranged in at least two different positions relative to the plurality of fixing means. The offset of the frame fixing element, viewed in the longitudinal direction of the fixing means arranged regularly in a row, in the two different positions results from the asymmetrical arrangement of the floor anchoring element.

In this way, it is possible to arrange the seat fixing system (and hence the seat frame) in the fixing means quickly and easily in at least two different positions offset to each other, and fix it therein. For this, merely the floor fixing element must be removed from the receiving space of the frame fixing element by releasing the at least one floor anchoring element, and the frame fixing element (for example together with the frame) is moved in the longitudinal direction of the plurality of fixing means; the floor fixing element is then turned (for example through 180°) and reinserted into the receiving space of the frame fixing element, and the at least one floor anchoring element is refitted in the corresponding fixing means. Many more positions of the seat fixing system in the longitudinal direction of the plurality of fixing means can be achieved than with the former fixing systems which merely allow fixing in the spacing of the plurality of fixing means.

This furthermore allows retention of the regular spacing of the fixing means and hence the standardized points for transferring load to a vehicle component in which the plurality of fixing means are arranged. The load transfer points need not therefore be changed, and hence there is no need for a static restructuring of vehicle components. At the same time, the seat fixing system allows the variable arrangement of the (seat) frame with very limited installation height. For example, the installation height of the floor fixing assembly is no greater than for conventional seat fixing systems.

It is also possible that different floor fixing elements are provided, each with a different distance between the center axis of the floor anchoring element and the end situated in the longitudinal direction of the floor fixing element. In this way, by exchanging the floor fixing element, the frame fixing element and hence the frame may be arranged differently relative to the fixing means (and hence also relative to the vehicle floor) and secured. Because there are two possible insertion positions for the floor fixing element (rotated through 180°), only half the floor fixing elements need to be provided in order to create a specific sub-matrix of adjustment possibilities for the frame fixing element within the spacing of two fixing means. Thus for example, with a spacing between two fixing means of 1 inch (2.54 cm) according to the present standard, with only 12 floor fixing elements, the frame fixing element can be arranged in a matrix of approximately 1 mm within this inch. When circular floor fixing elements with spirally arranged openings for a floor anchoring element/floor anchoring elements are used, it is sufficient to provide only a single floor fixing element. This may for example be divided into 12 segments, each having openings offset by 1 mm in the radial direction for a floor anchoring element.

In the same way, the number of fixing means may also be reduced. For example, the distance between the fixing means may also be 2 inches, while by providing a single floor fixing element, the frame fixing element can be shifted in a matrix of 1 inch and secured. Thus weight can be saved since the number of fixing means (which are often not used) is significantly reduced.

The plurality of fixing means may take the form of openings of the seat rail and webs between two openings. The openings or webs of the seat rail are arranged with regular spacing so that they constitute the fixing means arranged regularly in a row. This may be a so-called Douglas rail. Here, at least one floor anchoring element may be inserted into the seat rail through a corresponding opening therein, and by shifting in the longitudinal direction of the seat rail, be brought into engagement with one of the webs of the seat rail. In particular, at least one portion of the floor anchoring element may overlap vertically with a web, i.e., the portion of the floor anchoring element lies below a web perpendicularly to the longitudinal axis of the seat rail.

Alternatively, the plurality of fixing means may also be a plurality of individual anchoring elements. For example, the individual anchoring elements may be integrated (installed) in a floor of the vehicle with regular spacing in a line. In particular, for vehicle floors made of fiber-reinforced plastic material, the individual anchoring elements may be inserted directly into the plastic material, and secured by force fit due to the hardening of the plastic material. It is also possible to subsequently glue the fixing means into the vehicle floor.

In an implementation variant, the individual anchoring elements have an opening and a cavity extending away from the opening. After installation of such an anchoring element in the vehicle floor, the opening extends downward from a surface of the vehicle floor on which the fixing system is arranged. A thread may be provided in this (vertical) extension, or a cross-section of the opening may widen so that the side faces of the opening form a cone. This allows a seat fixing system or a floor fixing assembly to be secured to one or more floor anchoring elements which have a spreading effect. For example, an end of the floor anchoring element remote from a body of the floor fixing element may widen out (expand), so that the floor anchoring element spreads and wedges in the opening of the anchoring element. In both cases, the floor fixing assembly or seat fixing system is securely attached to the vehicle floor.

According to a further aspect, a seat comprises a seat frame and at least one seat element. The seat frame may be attached to at least one floor fixing assembly according to the first aspect. Alternatively or additionally, the seat fixing system according to the second aspect may be extended to include a seat element and be attached to the plurality of fixing means. The seat element may comprise a seating surface with or without a backrest.

Furthermore, the seat frame may comprise a seat leg and a seat foot. It is possible that the seat leg is fitted with a floor fixing assembly with an individual floor anchoring element arranged asymmetrically in the associated floor fixing element. Also, the seat foot may be equipped with a floor fixing assembly with two floor anchoring elements arranged asymmetrically in the associated floor fixing element. In other words, the seat leg is attached to a floor fixing element with a single floor anchoring element, while the seat foot is secured via two floor anchoring elements.

According to a further aspect, an aircraft comprises a seat fixing system according to the second aspect and/or a seat according to the third aspect.

The aircraft may comprise a floor and additionally a plurality of fixing means inserted by force fit into the floor and arranged regularly in a row. Alternatively or additionally to the fixing means, the aircraft may also comprise at least one seat rail coupled to the floor by force fit.

Alternatively instead of a seat, or additionally, a table, a partition wall, a luggage compartment, a storage space or another monument may be attached to a vehicle floor by means of a floor fixing assembly according to the first aspect and/or by means of a seat fixing system according to the second aspect. The elements and components concerning a seat and explained for each of the above-mentioned aspects, such as, for example, a seat frame or seat fixing system, apply accordingly to the table, the partition wall, the luggage compartment, the storage space or any other monument.

The embodiments, variants and aspects described here may furthermore be combined arbitrarily so as to include further embodiment variants which are not explicitly described.

Exemplary embodiments of the invention are explained in more detail below with reference to the drawings.

### BRIEF DESCRIPTION OF THE DRAWINGS

FIGS. 1A and 1B show, in perspective view, two possible embodiments of a floor fixing assembly,

FIG. 2 shows diagrammatically a vehicle floor with a plurality of fixing means arranged regularly in a row,

FIGS. 3A and 3B show diagrammatically a sectional view and a top view of an individual fixing means, respectively,

FIG. 4 shows diagrammatically a perspective depiction of the seat rail with a conventional fixing element and floor fixing element according to the present disclosure,

FIG. 5 shows in perspective view a frame with two different floor fixing assemblies,

FIG. 6 shows in perspective view the frame from FIG. 5 in an offset arrangement with reversal of the floor fixing elements, and

FIG. 7 shows diagrammatically an aircraft with a seat fixing system.

### DETAILED DESCRIPTION OF THE PREFERRED EMBODIMENTS

According to the present invention, a floor fixing assembly is described, with an asymmetrically arranged floor anchoring element in a floor fixing element, and a seat fixing system, a seat and an aircraft, in each case with such a floor fixing assembly.

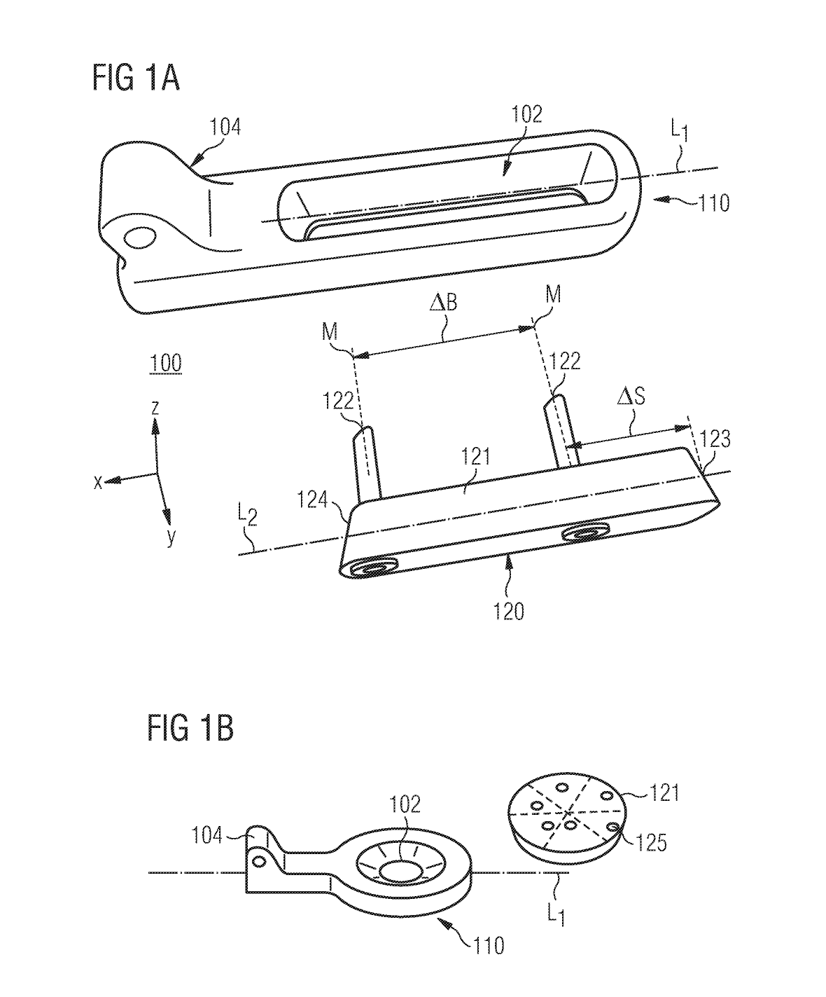

FIG. 1A shows, in perspective view, a possible embodiment of a floor fixing assembly 100. The floor fixing assembly 100 comprises a frame fixing element 110 which has a connection facility 104 for a leg or foot of a frame. As well as this connection facility 104, the main body of the frame fixing element 110 comprises a receiving space 102. The receiving space 102 serves to receive a further component for attaching the frame fixing element 110 to a vehicle floor, for example.

For this, the floor fixing assembly 100 comprises a floor fixing element 120 which may be inserted by form fit into the receiving space 102. For this, the floor fixing element 120 has a body 121 which has a shape corresponding to the receiving space 102. The floor fixing element 120 furthermore comprises at least one floor anchoring element 122 which serves for fixing to the vehicle floor.

For example, the body 121 of the floor fixing element 120 may have an elongate form and a symmetrical periphery Similarly, the receiving space 102 may have an elongate form which is symmetrical in a cross-section parallel to a longitudinal axis L1 of the receiving space 102. By virtue of the symmetrical periphery, the body 121 of the floor fixing element 120 may be inserted into the receiving space 102 in two mutually opposing directions. For this, both the receiving space 102 and the body 121 of the floor fixing element 120 have an elongate form, wherein a longitudinal axis L1 of the receiving space 102 and a longitudinal axis L2 of the floor fixing element 120 run parallel to each other or coincide with each other in the assembled state. The body 121 of the floor fixing element 120 may be rotated through 180° so that its longitudinal axis L2 again runs as before, but the two ends 123, 124 of the body 121 are arranged reversed in the receiving space 102 of the frame fixing element 110.

As shown in FIG. 1A, the body 121 of the floor fixing element 120 has a symmetrical form in a cross-section parallel to a longitudinal axis of the body 121. This allows the body 121 to be inserted into the receiving space 102 in each of the two positions described above, i.e., rotated through 180°. Furthermore, the at least one floor anchoring element 122 is arranged asymmetrically to a plane which is arranged perpendicularly to the longitudinal axis L2 of the floor fixing element 120 and centrally in the longitudinal direction of the body 121. Thus, for example, the floor anchoring element 122 shown on the right in FIG. 1A is not arranged in the center of the body 121 nor at the end 123 of the body 121 on the right in the figure.

The flange shown in FIG. 1A, on the lower end of the receiving space 102 in the viewing direction of FIG. 1A, is optional. It may serve as a further form-fit connection between the receiving space 102 and the body 121 of the floor fixing element 120, wherein the body 121 does not come into contact with a vehicle floor. In this way, the body 121 cannot damage the vehicle floor, and furthermore the body 121 cannot be pushed or pulled out of the lower portion of the receiving space 102 by over-tightly fixing the at least one floor anchoring element 122, and hence the frame lifting element 110 cannot be lifted away from the vehicle floor.

FIG. 1B shows in perspective view a further possible embodiment of a floor fixing assembly 100. All details described above in relation to the embodiment shown in FIG. 1A apply, wherein now the forms of the receiving space 102 and body 121 of the floor fixing element 120 have a circular cross-section. They may also be conical, in order to achieve a form-fit and force-fit retaining connection between the receiving space 102 and the body 121. Openings 125 are provided in the body 121 for receiving a respective floor anchoring element 122. Each opening 125 has a different distance from the outside of the body 121 as viewed in the radial direction, so by turning the body 121 in the receiving space 102, a corresponding offset of the floor anchoring element 122 in relation to the longitudinal axis L1 of the frame fixing element 110 is achieved.

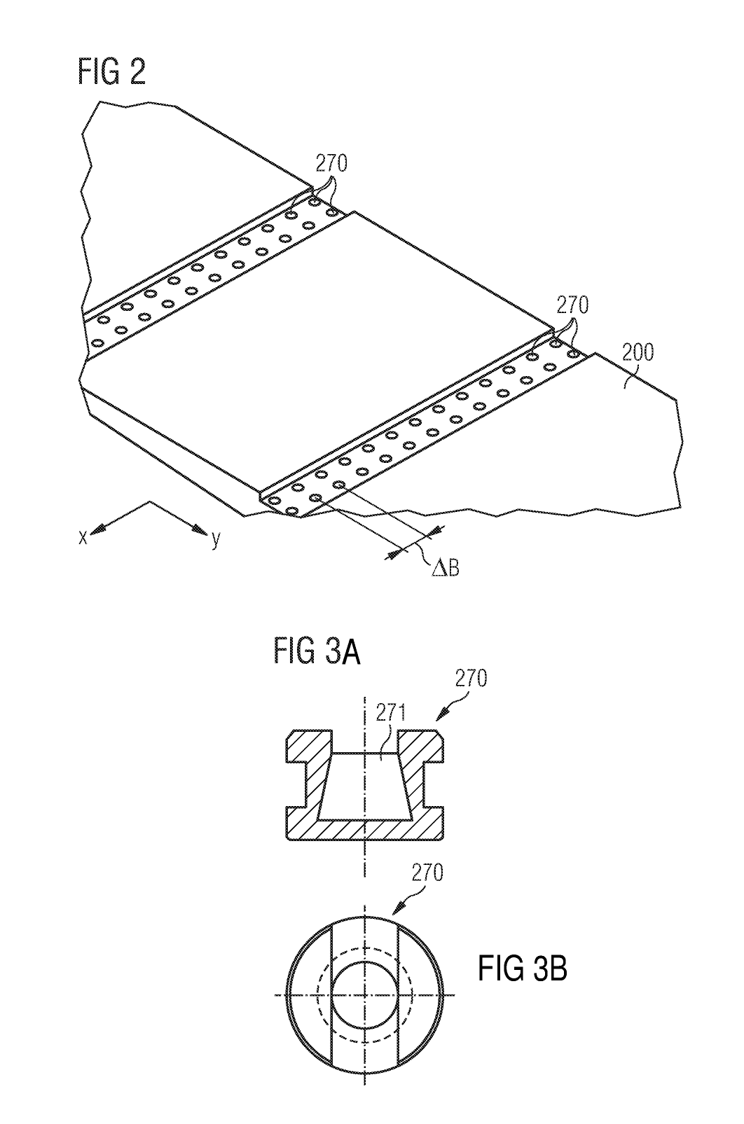

FIG. 2 shows diagrammatically a vehicle floor 200 with a plurality of fixing means 270 arranged regularly in a row. The plurality of fixing means 270 arranged in a row may run along a longitudinal direction (X-axis) of the vehicle. It is also possible, as shown in FIG. 2, that several rows of fixing means 270 are provided in the vehicle floor 200. FIG. 2 furthermore shows the option of arranging rows of fixing means 270 in pairs.

Each of the fixing means 270 is configured to receive a floor anchoring element 122, wherein each floor anchoring element 122 may be coupled by force fit to the fixing means 270. For example, FIGS. 3A and 3B show diagrammatically a sectional view and a top view of a single fixing means 270. The fixing means 270 has an opening and/or depression 271 in which a floor anchoring element 122 may be received. The variant of the opening or depression 271 shown in FIG. 3A has a conical, inwardly widening form. This allows a floor anchoring element 122 to spread for force-fit connection.

The regular spacing ΔB of two adjacent fixing means 270 (along the row of fixing means 270, i.e., in the direction of the X-axis) may here be a standardized spacing. Alternatively, any arbitrary spacing ΔB is possible, as long as it is always the same between two adjacent fixing means 270, so that standardized frames (for example, for seats, tables, monuments and other objects) may be attached thereto at any arbitrary position in the X-axis direction.

The floor fixing element 120 shown in FIG. 2 has, for example, two floor anchoring elements 122 to guarantee better anchoring of the floor fixing element 120 and hence also of the frame fixing element 110. For example, moments may also be transmitted through the two floor fixing elements 122. The spacing of the respective center axes M of the two floor anchoring elements 122 here corresponds to the spacing ΔB of the regularly arranged fixing means 270.

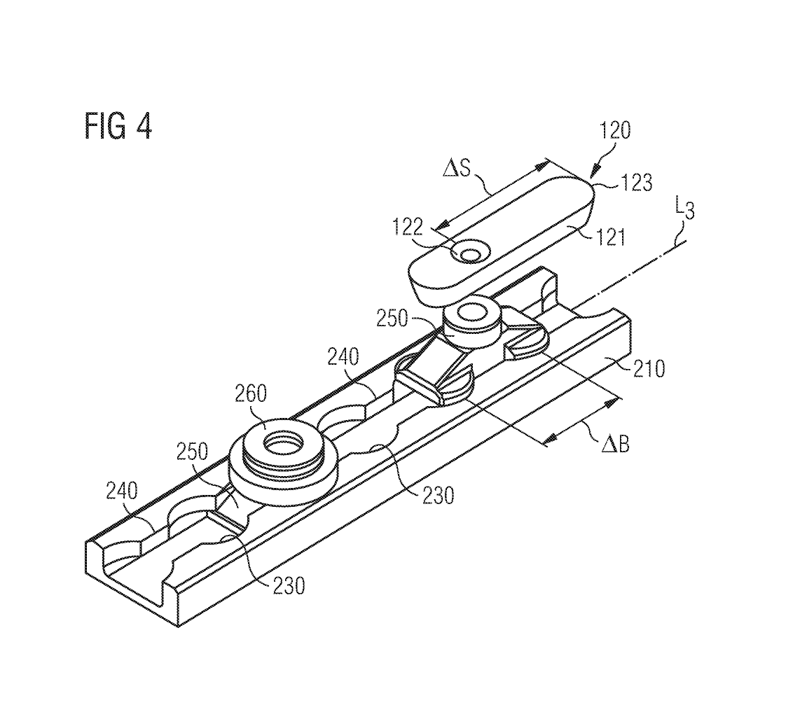

FIG. 4 shows diagrammatically a perspective depiction of a seat rail 210 with a conventional fixing element 260 and floor fixing element 120. The seat rail 210 has openings 230 and webs 240 between two openings 230, which also constitute a plurality of fixing means 230, 240 arranged regularly in a row. Such a seat rail 210 may also be arranged in the longitudinal direction of the vehicle (X-axis) so that frames may be arranged and secured arbitrarily in the longitudinal direction of the vehicle.

Whereas with the conventional fixing element 260, a base structure 250—which can be inserted through the openings 230 and moved in the longitudinal direction of the seat rail 210—is brought into engagement with the webs 240, the floor fixing element 120 is arranged asymmetrically on the base structure 250. In this way, a floor fixing element 120 (not shown in FIG. 4) may be attached to a conventional seat rail. In other words, the floor fixing element 120 has floor anchoring elements 122 which have a form corresponding to the base structure 250.

FIG. 5 shows in perspective view a frame 300 with two different floor fixing assemblies 100A, 100B. The floor fixing assemblies 100A, 100B differ only in their length, and, in particular, in the length of the respective receiving space 102 and the length of the respective floor fixing element 120. The floor fixing assembly 100B is attached to a vehicle floor 200 by a floor fixing element with two floor anchoring elements 122. FIG. 5 also shows the individual fixing means 270 arranged regularly in a row and depicted in FIG. 2, with which the floor anchoring elements 122 may be attached to the vehicle floor 200.

The frame 300 shown in FIG. 5 is suitable for fixing a vehicle seat. The seat fixing system 400 shown in FIG. 5 comprises, as well as the floor fixing assemblies 100, a seat leg 310 and a seat foot 320. The seat leg 310, normally provided at the front in the direction of travel of the vehicle, receives primarily vertical loads (in the direction of the Z-axis) and is therefore attached to the vehicle floor 200 with a floor fixing assembly 100A with just a single floor anchoring element 122. The seat foot 320, normally provided at the rear in the direction of travel of the vehicle, runs obliquely to the seat leg 310, whereby as well as transverse loads (horizontal loads), moments must also be transferred to the vehicle floor 200. For this, the floor fixing assembly 100 depicted is provided with two floor anchoring elements 122.

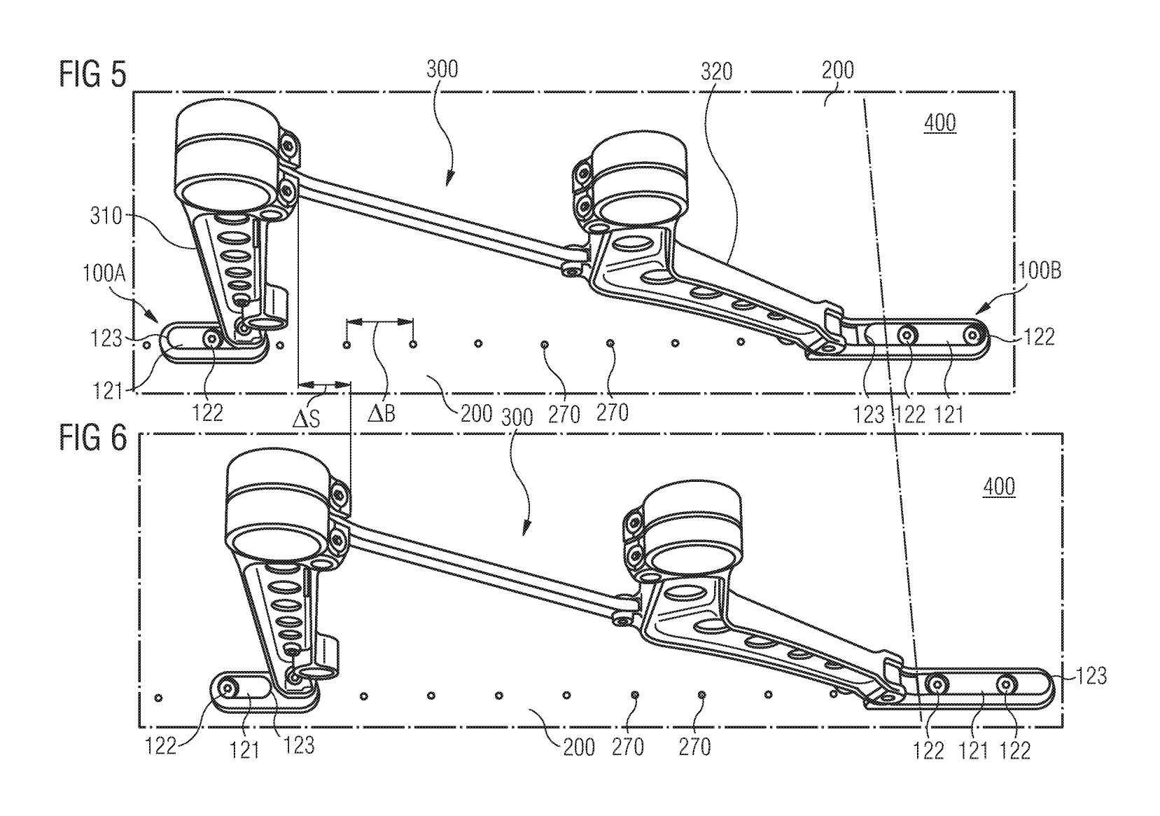

FIG. 6 shows the same seat fixing system 400, wherein the respective floor fixing element 120 has been rotated through 180° and inserted into the floor fixing assembly 100. In order to bring the respective floor anchoring elements 122 into engagement with the fixing means 240, 270 provided in the vehicle floor 200, the seat frame 300 is shifted by a distance ΔS. This distance ΔS corresponds to a distance shown in FIG. 1 between a center axis M of the floor anchoring element 122 and an end 123 of the floor fixing element 120 situated in the longitudinal direction. The distance ΔS may be selected arbitrarily, i.e., various floor fixing elements 120 may also be provided, for which each floor anchoring element 122 is provided at a respective different but asymmetrical position along the longitudinal axis L2 of the body 121 of the floor fixing element 120. If the distance ΔS is selected so as to be smaller than the distance ΔB between two adjacent fixing means 240, 270, the frame 300 can be shifted arbitrarily in the longitudinal direction of the vehicle (X-axis) while the fixing means 240, 270 form constant load transfer points to the floor 200 of the vehicle.

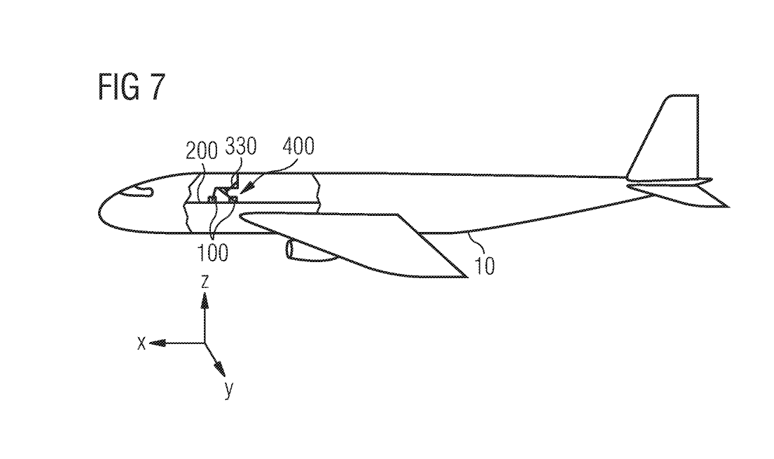

FIG. 7 shows diagrammatically an aircraft 10 with a seat fixing system 400 and a seat 330. The seat fixing system 400 is attached to a floor 200 of the aircraft 10 via at least one floor fixing assembly 100.

Instead of a seat 330, a fixing system 400 may be used to fit any components provided in the interior of the aircraft 10. For example, a table, a luggage compartment, a storage space, a partition wall, a vehicle toilet, a vehicle galley etc. may be attached to the floor 200 of the aircraft 10 via a fixing system 400 and in particular at least one floor fixing assembly 100.

The variants, designs and exemplary embodiments discussed above serve merely to describe the claimed teaching but do not restrict this to the variants, designs and exemplary embodiments.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A floor fixing assembly for variable fixing of a frame to a vehicle floor, comprising:
a frame fixing element which is configured to be connected to a leg or a foot of the frame and which comprises a receiving space;
a floor fixing element which is configured to be inserted by form fit into the receiving space and which comprises at least one floor anchoring element,
wherein the at least one floor anchoring element is arranged asymmetrically in the floor fixing element.

2. The floor fixing assembly according to claim 1,
wherein a body of the floor fixing element has a symmetrical periphery, and
wherein the body of the floor fixing element is configured to be inserted into the receiving space in at least two mutually opposing directions.

3. The floor fixing assembly according to claim 2,
wherein the body of the floor fixing element has an elongate form which is symmetrical in a cross-section parallel to a longitudinal axis of the body, and
wherein the at least one floor anchoring element is arranged asymmetrically relative to a plane arranged perpendicularly to the longitudinal axis of the body of the floor fixing element and centrally in a longitudinal direction of the body.

4. The floor fixing assembly according to claim 2,
wherein the body of the floor fixing element has a circular form and comprises through openings at specific angular spacings, and
wherein each opening is configured to receive a floor anchoring element and has a different distance in a radial direction from a peripheral outside of the body of the floor fixing element.

5. The floor fixing assembly according to claim 1, wherein the receiving space has an elongate form which is symmetrical in a cross-section parallel to a longitudinal axis of the receiving space.

6. The floor fixing assembly according to claim 1, wherein the receiving space has a circular form.

7. A seat fixing system, comprising:
a plurality of fixing means arranged regularly in a row, and
a seat frame,
wherein the seat frame is attached to at least one floor fixing assembly according to claim 1.

8. The seat fixing system according to claim 7, wherein the floor fixing element of the floor fixing assembly comprises two floor anchoring elements with a spacing which corresponds to a regular spacing of the fixing means arranged in a row.

9. The seat fixing system according to claim 7, wherein a spacing between the center axis of one of the at least one floor anchoring elements and an end of the floor fixing element situated in a longitudinal direction is smaller than the regular spacing of the fixing means arranged in a row.

10. The seat fixing system according to claim 7, wherein the plurality of fixing means are openings of a seat rail and webs between two openings.

11. The seat fixing system according to claim 7, wherein the plurality of fixing means is a plurality of individual anchoring elements.

12. A seat, comprising:
a seat frame, and
at least one seat element,
wherein the seat frame is attached to at least one floor fixing assembly according to claim 1.

13. The seat according to claim 12, wherein the seat frame comprises a seat leg and a seat foot, wherein the seat leg is fitted with a floor fixing assembly with a single floor anchoring element arranged asymmetrically in the associated floor fixing element, and wherein the seat foot is fitted with a floor fixing assembly with two floor anchoring elements arranged asymmetrically in the associated floor fixing element.

14. An aircraft comprising a seat fixing system according to claim 7.

15. The aircraft according to claim 14, furthermore comprising:
a floor, and
a plurality of fixing means inserted into the floor by force fit and arranged regularly in a row.

16. The aircraft according to claim 14, furthermore comprising:
a floor, and
at least one seat rail coupled by force fit to the floor.

17. An aircraft comprising a seat according to claim 12.

18. The aircraft according to claim 17, furthermore comprising:
a floor, and
a plurality of fixing means inserted into the floor by force fit and arranged regularly in a row.

19. The aircraft according to claim 17, furthermore comprising:
a floor, and
at least one seat rail coupled by force fit to the floor.
